(19) United States
(12) Patent Application Publication
(10) Pub. No.: US 2022/0372721 A1
(43) Pub. Date: Nov. 24, 2022

(54) MARINE TILES, PODS, TANKS AND METHODS OF USE THEREOF

(71) Applicant: King Abdullah University of Science and Technology, Thuwal (SA)

(72) Inventors: Sebastian Schmidt-Roach, Thuwal (SA); Carlos M. Duarte, Thuwal (SA); Manuel Aranda Lastra, Thuwal (SA); Charlotte A.E. Hauser, Thuwal (SA)

(21) Appl. No.: 17/767,251

(22) PCT Filed: Oct. 7, 2020
(86) PCT No.: PCT/IB2020/059417

§ 371 Date: Apr. 7, 2022

Related U.S. Application Data
(60) Provisional application No. 62/912,032, filed on Oct. 7, 2019.
(60) Provisional application No. 62/954,432, filed on Dec. 28, 2019.
(60) Provisional application No. 62/954,435, filed on Dec. 28, 2019.

(51) Int. Cl. E02B 3/04; A01K 63/00

(52) U.S. Cl. CPC E02B 3/046; A01K 63/006; A01K 63/045

(57) ABSTRACT

Portable and interchangeable marine tiles, marine pods and tanks are disclosed. The marine tile typically contains a first face, a second face, and one or more sites for supporting one or more marine organisms, such as coral, and. may contain a tracking device. The marine pod typically contains a first panel having a first slit and a second panel having a second slit. The first panel and the second panel can be interlocked via sliding the first slit into the second slit. The marine pod can have one or more marine tiles attached thereto. The marine tank typically contains one or more coral reef organisms. Water can be pumped into and through the marine tank to flow in the form of a river stream. Typically, the flow of the seawater is controlled such that a consistent temperature is maintained in the marine tank.

### CROSS-REFERENCE TO RELATED APPLICATION

The present application claims priority to U.S. Application No. 62/912,032, filed Oct. 7, 2019, U.S. Application No. 62/954,432, filed Dec. 28, 2019, and U.S. Application No. 62/954,435, filed Dec. 28, 2019, the disclosures of which are incorporated herein by reference in their entirety.

### FIELD OF THE INVENTION

The field of the invention generally relates to marine tiles, pods and tanks, containing coral reef organisms.

### SUMMARY OF THE INVENTION

Portable and interchangeable marine tiles are disclosed. The marine tile typically contains a first face and a second face, where the first face comprises a combination of projections and spaces that together form a 3D pattern. The marine tile may contain one or more attachment sites for attaching to an artificial supporting substrate. The marine tile may further contain a mark, a label, or a miniature electronic transmitter tracking device.

In some embodiments, the disclosed marine tile contains a first face, a second face, and one or more sites for supporting one or more marine organisms, where the one or more sites are located on the first face. The first face may or may not contain a 3D pattern. The one or more marine organisms can be glued, cemented, clipped, plugged, or screwed to the sites. Further, smaller tiles/substrate with organisms on them can be glued, cemented, clipped, plugged, or screwed to the sites. The marine tile may contain one or more attachment sites for attaching to an artificial supporting substrate. In some preferred embodiments, the one or more marine organisms include coral. The marine tile may also contain a mark, a label, or a miniature electronic transmitter tracking device.

Marine organisms such as coral may be mounted to the tiles on smaller tiles or directly via screws, clips, or plugs in a way that allows detachment, transfer and reattachment to another tile or direct placement on marine substrate. Direct placement on the marine substrate may be facilitated via screws, plugs, nails or any combination of thereof.

Artificial structures containing an artificial supporting substrate and a plurality of the disclosed marine tiles are provided. The marine tiles are positioned individually or clustered together. The artificial supporting substrate can be a bridge pile, an overwater villa pile, a jetty pile, an underwater wall or artificial reef. In some embodiments, the marine tiles are arranged to form a mosaic pattern on the supporting substrate. The marine tiles may serve as a modular unit to grow corals in land-based coral gardens or underwater coral nurseries. The marine tiles can be attached to the artificial supporting substrate via screws, clips, glue, or nails.

Dismountable and transportable marine pods are also disclosed. These portable units are designed for the quick creation of substrate to grow marine organisms underwater. The marine pod typically contains a first panel having a first slit and a second panel having a second slit. The first panel and the second panel can be interlocked via sliding the first slit into the second slit. In some embodiments, the first panel and the second panel intersect at a 90-degree angle. The marine pod can have one or more marine tiles attached thereto, or may allow organisms to be attached directly using glue, cement, clips, plugs, or screws.

Methods of using the disclosed marine tiles and/or marine pods are disclosed. For example, they can be used for constructing an underwater garden in the ocean or outside the ocean, such as in a marine tank. They can also be used for constructing an aquatic living genebank (ALG), where each of the marine organisms is labeled, catalogued, sub-sampled, mapped, recorded, or a combination thereof using the disclosed marine tiles and/or marine pods containing a mark, a label, or a tracking device.

Marine tanks incorporating a river element and methods for using the marine tanks are also provided. The marine tank typically contains one or more coral reef organisms. Optionally, the marine tank further contains one or more additional marine organisms, such as clams, sponges, algae, or fish.

In some embodiments, the marine tank includes at least one vertical wall and in some embodiments, at least one horizontal wall. The marine tank can be a terraced, and in this embodiment, the tank include a plurality of vertical and horizontal walls, depending on number of terraces. The vertical wall is connected to the horizontal surface of the seawater tank. The seawater tank can include one or more pipes connected to a pump located inside or outside the seawater tank.

Typically, the one or more coral reef organisms are placed at a depth of at least 10 cm from the water level. The seawater tank may be a terraced tank or an individual tank, and may contain one or more transparent windows for displaying the one or more coral reef organisms. The terraced tank can include two or more terrace levels, where the one or more coral reef organisms are placed in the bottom terrace level of the seawater tank. The seawater tank may be open at the top to allow the passage of natural or artificial light. The marine tank may also include one or more lighting features and/or artificial illumination features for additional light and/or to showcase fluorescence of marine organisms and to create nocturnal landscape features. The disclosed tanks incorporate a river feature as opposed to standing water, and accordingly, are configured to allow water to flow and/or circulate into and out of the tank.

Methods of using the marine tank as a beautification feature and/or a nursery for coral reef organisms are also disclosed. Typically, the method includes pumping seawater through the disclosed marine tank.

The seawater can be directly pumped from the sea through the marine tank, or pumped from the sea to a holding tank or a Life Support System (LSS), then from the holding tank or LSS through the marine tank. Optionally, the method further includes a step of cooling, heating, or filtering the seawater prior to flowing through the marine tank. When the seawater tank is a terraced tank having more than one levels, the seawater can flow from an upper level and cascades downwards to a lower level/levels.

Typically, the flow of the seawater is controlled such that a consistent temperature of less than 32° C. is maintained in the marine tank. This is to be facilitated by controlling the intake water.

### BRIEF DESCRIPTION OF THE DRAWINGS

FIGS. 1A-1D are schematic representations of exemplary marine tiles containing different 3D structures/patterns.

FIG. 2 is a schematic representation of an exemplary artificial supporting substrate partially covered by marine tiles containing 3D structures/patterns.

FIG. 3 is a schematic representation of an exemplary marine tile containing a 3D structure/pattern for esthetic purposes, as well as features for supporting the marine organism.

FIG. 4 is a schematic representation of an exemplary marine tile containing coral cemented, glued, clipped, or plugged to the supporting site in the center.

FIG. 5 is a schematic representation of an exemplary pattern formed by marine tiles containing coral and blank tiles.

FIG. 6A is a schematic representation of an exemplary artificial supporting substrate covered by a plurality of marine tiles. The marine tiles are clustered together or placed individually on the supporting substrate.

FIG. 6B is a magnified view of one of the marine tiles attached on the supporting substrate. The marine tiles can contain coral that is different in type, size, shape, and/or color (FIGS. 6C-6E). Each marine tile can contain one or more marine organisms (FIGS. 6C-6E).

FIG. 7 is a schematic representation of an exemplary artificial supporting substrate partially covered by marine tiles containing coral. The marine tiles are clustered together.

FIG. 8A is a schematic showing an assembled view of an exemplary marine pod. FIG. 8B is a schematic showing the dismounted view of the exemplary marine pod depicted in FIG. 8A.

FIG. 9A is a schematic representation of an exemplary marine pod with blank marine tiles attached thereto. FIG. 9B is a schematic representation of an exemplary marine pod with marine tiles containing coral attached thereto.

FIG. 10 is a schematic representation of an exemplary coral farm constructed from a plurality of marine pods having marine tiles attached thereto.

FIG. 11 is a cartoon depicting an exemplary marine tank displaying a coral garden. The coral garden can have multiple configurations (color, species, types of organisms, and different illumination systems, including for nocturnal landscapes, etc.).

FIG. 12A is a cartoon depicting an exemplary bottom terrace level or individual seawater tank with a sloped bottom. FIG. 12B is a side view of the exemplary bottom terrace level or individual seawater tank depicted in FIG. 12A.

FIG. 13 is a cartoon depicting an exemplary marine tank with a three-level terraced seawater tank.

### DETAILED DESCRIPTION OF THE INVENTION

### I. Compositions

A. Marine Tiles

Marine tiles are disclosed. In some embodiments, the marine tiles are for the ecological restoration and gardening of marine benthic organisms (including, but not limited to, corals, bivalves, sponges, and algae). For example, the marine tiles have features combining architectural design with environmental functionality that serve to beautify underwater structures and as interchangeable units for marine gardening efforts for nursery or restoration purposes.

i. Structure of Marine Tiles

The marine tiles are typically portable and/or interchangeable tiles. For example, the disclosed marine title is light in weight small in size to allow easy portability, for example, it can be lifted and transported by a human, including children.

In some embodiments, the disclosed marine title can have a weight less than 50 lbs, less than 45 pounds, less than 40 lbs, less than 35 lbs, less than 30 lbs, less than 25 lbs, less than 20 lbs, less than 15 lbs, less than 10 lbs, less than 5 lbs, less than 4 lbs, less than 3 lbs, less than 2 lbs, between 2 and 30 lbs, between 2 and 25 lbs, between 2 and 20 lbs, between 2 and 15 lbs, or between 2 and 10 lbs.

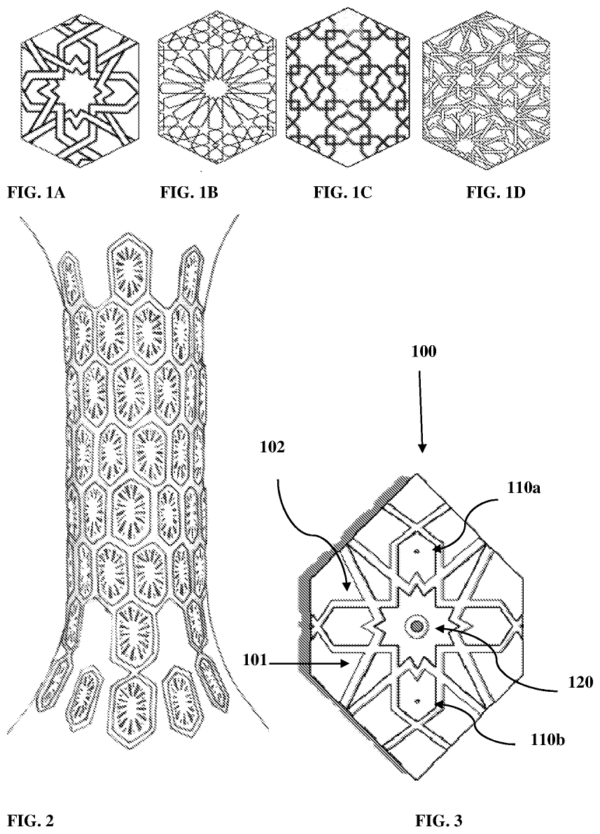

The marine tile can have any suitable shapes, such as regular shapes and irregular shapes. Exemplary shapes of the marine tiles include, but are not limited to circles, rectangular, square, polygonal shapes in addition to square and rectangular (e.g., trapezoidal, triangular, pentagonal, hexagonal, etc), oval, ellipsoid, donut-shaped. The polygonal shapes described above may be regular or irregular. For example, the marine tile can have a hexagonal shape with unequal length (see, e.g., FIGS. 1A-1D). In some embodiments, the largest dimension of the marine tile (i.e., the longest edge) is at least 2 cm, at least 5 cm, at least 10 cm, 15 cm, at least 20 cm, at least 30 cm, at least 40 cm, at least 50 cm, at least 60 cm, up to 100 cm, up to 150 cm, at least 200 cm, up to 1 m, up to 900 cm, up to 800 cm, up to 700 cm, up to 600 cm, up to 500 cm, up to 450 cm, up to 400 cm, up to 350 cm, up to 300 cm, up to 250 cm, between 100 cm and 1 m, between 100 cm and 900 cm, between 100 cm and 800 cm, between 100 cm and 700 cm, between 100 cm and 600 cm, or between 100 cm and 500 cm.

The marine titles can be 3D-printed or molded from any suitable materials, such as ceramics, cement, porcelain, glass, quarry, stone, limestone, etc.

Typically, the marine title has two faces. A first face of the marine tile can contain a 3D structure for esthetic purposes. Exemplary, non-limiting tiles containing different 3D structures are illustrated in FIGS. 1A-1D. The opposite face (i.e., a second face) of the marine tiles may contain the same 3D structure or a different 3D structure than the first face, or is flat (i.e., does not contain a 3D structure). Alternatively or additionally, the opposite face of the marine tile can contain one or more ridges and/or grooves for holding the tile in sand or rocky bottom of the seashore line, or for improving the attachment to a surface of an artificial structure (e.g., bridge piles, overwater villa piles, jetty piles).

In some embodiments, small tiles are designed to provide reef nails. The reef nails are made from conventional nails used on construction, preferably concrete nails, which include a head, shank and point. In this embodiment, the tile is designed like a conventional nut with thread nuts in a central opening. In this embodiment, a screw nut with external (male) thread nuts (for mating with the internal (female) thread nut in the central portion of the nut) is made from the same or similar material as the tiles and attached to one end of a conventional nail. The screw nut has a central opening, that corresponds with and mates firmly with the head of the nail. Thus, if the head of the nail is round, the screw nut is designed with a round central opening to engage the round nail head. The reef nail is assembled by engaging the screw nut onto the nail head, and fastening the tile nut onto the screw nut. This results in a reef nail, with the tile now replacing the head of the nail, and the point of the conventional nail exposed and usable to attach the reef nail where desired. Reef nails allow for fast deployment of coral attached to the tile.

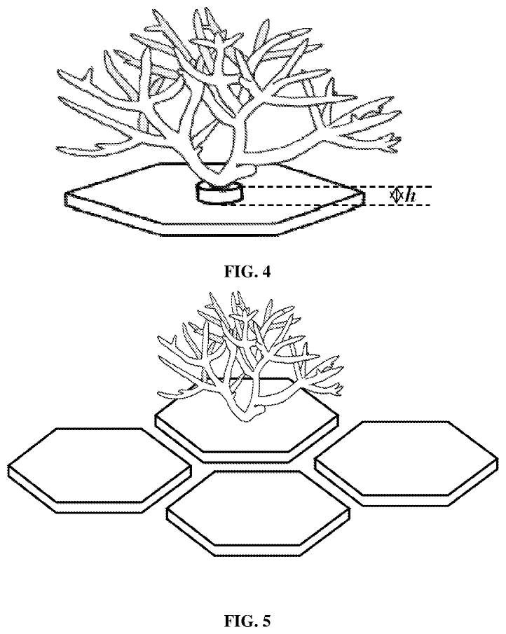

The marine tiles may have one or more points for attachment to a surface of a supporting substrate, such as a rope, a pipe, or a pod. The marine tiles may be attached via screws, clips, glue/adhesive, etc. The number of points for attachment depends on the size of the marine tile and the structure to be attached to. For example, the marine tile can contain more than one points for attachment, such as two points, three points, four points, five points, six points, etc. The point(s) for attachment can be arranged at any location suitable on the tile (see, e.g., FIGS. 3, 110a and 110b). The points for attachment can be in the form of holes.

In some embodiments, the marine tiles can attach to and detach from artificial supporting substrates (bridge piles, overwater villa piles, jetty piles, etc.) to construct an artificial structure. The marine tiles can be attached to a surface of the supporting substrate in any desirable angles, such as in parallel or vertical directions. The marine tiles can be placed individually or clustered next to each other in mosaic patterns on the artificial supporting substrates. The marine tiles can cover part of, or all of, or are otherwise used to construct the artificial supporting substrates. The marine titles containing a variety of 3D structures can be adjusted during or directly after construction to make the artificial supporting substrates visually appealing (see, e.g., FIG. 2) and/or to attract recruitment of marine benthic larvae. The interchangeability of the tiles allows for the specific arrangement of marine tiles to form any desirable patterns, such as mosaic patterns.

In some embodiments, each marine tile can contain a unique mark, label, RFID chip, or a miniature electronic transmitter tracking device, to provide an identifiable and trackable platform. The miniature electronic transmitter tracking device may include a transmitter, a component to propagate a signal (e.g., an antenna), a power supply (e.g., a battery), and optionally a non-transitory computer readable storage medium (e.g., a memory). Exemplary miniature electronic transmitter tracking devices include, but are not limited to, tracking devices using radio frequency (e.g., a RFID chip), electromagnetism, and global positioning satellite technology. The miniature electronic transmitter tracking device may be embedded in the tile or affixed to the tile. In some embodiments, the miniature electronic transmitter tracking device can be paired with a receiver that can track the tile in case it is lost or stolen. The miniature electronic transmitter tracking device may remain passive until remotely activated or read, or under continuous operation.

ii. Marine Tiles with Marine Benthic Organisms

The title can serve as a substrate to recruit larvae or transplant and grow marine benthic organisms (e.g., corals, coral fragments, bivalves, sponges, algae, claims, etc.) in ex-situ or in-situ environments. For example, the titles serve as a substrate to grow coral reef organisms before or after placement on pre-adjusted artificial supporting substrates (e.g., bridges, jetties, piles supporting overwater units, etc.).

Typically, the marine tile that serves as a substrate contains one or more sites on the first face of the tile for supporting the marine benthic organisms. The marine benthic organism, such as coral or coral fragments, can be glued, cemented, clipped, or plugged to the site on the first face of the marine tile. The first face may or may not contain a 3D structure. The one or more sites may or may not extrude from the surface of the first face. For example, the upper edge of the site may align with the surface of the first face. Alternatively, the upper edge of the site extrudes from the surface of the first face and has a height (h) above the surface of the first face (see, e.g., FIG. 4).

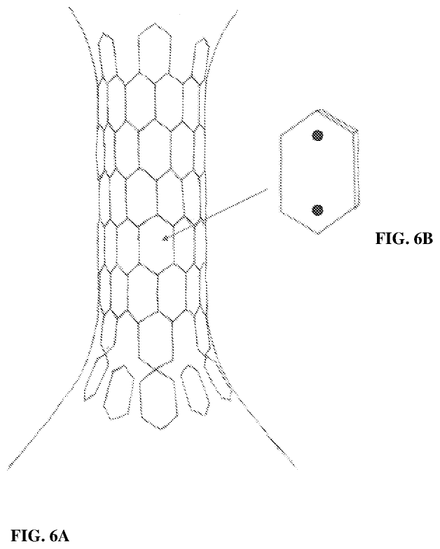

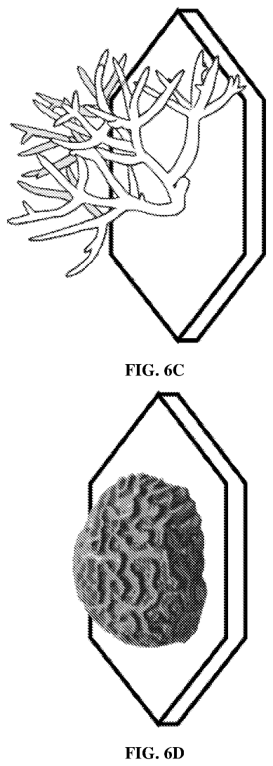

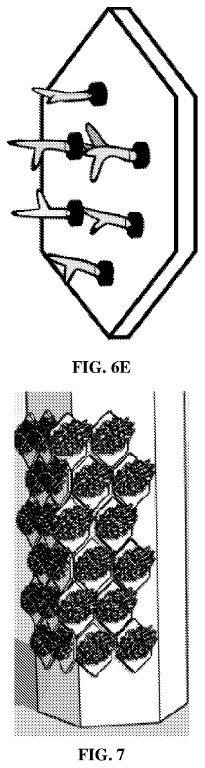

The one or more sites may be at any locations on the marine tile. For example, the site may be in the form of a hole passing partially through the title, which may or may not be centrally located on the tile. Alternatively, the marine titles contain more than one site for supporting the same or different marine benthic organisms, where the sites can locate at any relative positions on the tile. For example, the marine tile contains a first site and a second site located at a distance from each other on the first surface of the tile, where the first site supports a first coral and the second site supports a second coral that is different from the first coral (see, e.g., FIG. 6E). The coral may be different in type, size, shape, and/or color.

The site may have any suitable shapes, such as a circle, a square, a rectangular, an oval, an ellipsoid, etc. For example, the site may be a circular hole, a rectangular hole, a square hole, an oval hole, etc.

The site typically has a depth from the surface of the first face of the tile that is suitable for supporting the marine benthic organism. The depth of the site depends on the type and size of marine benthic organism to be supported, the size of the marine tile, the structure to which the tile is attached, etc.

FIG. 3 shows an exemplary marine title that can serve as a substrate for a marine benthic organism, such as coral. As shown in FIG. 3, marine tile 100 contains a first face 101, which contains a 3D structure 102. The marine tile 100 contains a site 120 for supporting a marine benthic organism. The tile also contains a first hole 110a and a second hole 110b located on the opposite sides of the site 120 for attaching the tile to a surface of a structure.

The marine tile can contain a unique mark, label, or any of the miniature electronic transmitter tracking devices described above. In addition to tracking the status of the tile (e.g., lost or stolen from the attachment structure), such mark, label, or tracking device also allows to create records of the origin of each transplanted organism/fragment, the species classification, its previous placement in garden efforts, past performance, growths, resilience, etc.

The interchangeability of the marine tiles allows for any combinations and arrangements of any of the titles described above to form any desirable patterns, such as tiles without 3D structures, tiles with 3D structures, tiles with the marine organisms, and tiles with a 3D structure and marine organisms. For example, tiles without 3D structures and tiles with coral may be arranged to form a pattern (see, e.g., FIG. 5). The combination and arrangement of different types of tiles are highly tailorable according to the organism's habitat conditions as well as beautification/design purposes.

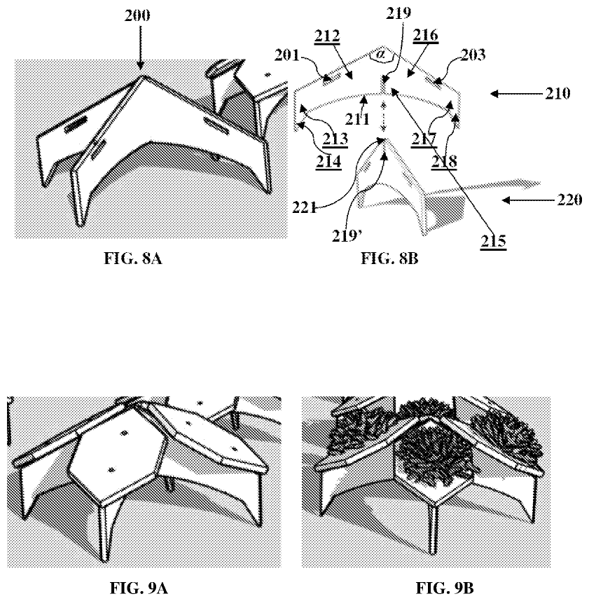

In some embodiments, the marine tiles with the same, substantially the same, or different marine organisms can attach to and detach from artificial supporting substrates (bridge piles, overwater villa piles, jetty piles, etc.). In some embodiments, all marine tiles that are attached to the artificial supporting substrates contain coral, where the coral supported on each of the marine tiles may be the same, substantially the same, or different in type, size, shape, and/or color from one another (see, e.g., FIG. 7). In some embodiments, at least one of the attached marine tiles do not contain a marine organism, and one or more of the attached marine tiles contain coral, where the coral supported on each of the marine tiles may be the same, substantially the same, or different in type, size, shape, and/or color from one another (see, e.g., FIGS. 6A-6E).

As described above, the marine tiles with marine organisms can be attached to a surface of the artificial structures in any desirable angles, such as in parallel or vertical directions. The marine tiles with the same, substantially the same, or different marine organisms can be placed individually or clustered next to each other in mosaic patterns on the artificial supporting substrates. The marine tiles can be arranged such that marine organisms cover part of, or all of the artificial supporting substrates. In some embodiments, the marine titles containing a variety of marine organisms can be adjusted during or after attachment of the marine titles to form any desirable patterns. For example, the artificial structure can be covered partially or entirely with marine titles that contain coral of different size, shape, or color to make the artificial structure visually appealing (see, e.g., FIG. 6A-6E).

B. Marine Pods

Marine pods are also disclosed. The marine pods are typically dismountable and transportable unit. The marine pod can serve as a base structure underwater to deploy one or more substrates, such as one or more marine tiles, or to grow and/or settle marine organisms directly on the pods (including, but not limited to, corals, bivalves, sponges, and algae) underwater. The marine pods allows gardening, habitat extension, or artificial reef projects, for example, quick creation of nurseries or farms underwater on different subjects/locations (coral gravel, sand, etc.).

The ability to quickly dismount, transport, and re-assemble the marine pods with or without substrates make them ideal for operations in the marine environment where space for transportation and assembly time underwater are limited. This also reduces time of recovery at the end of use.

i. Structure of Marine Pods

Generally, the marine pod includes a first panel and a second panel that are assembled together. The panels can be constructed from any submergible and durable materials, such as PVC, acrylic, etc. Each of the first panel and second panel is a unitary piece and can have any suitable shape and dimensions, as long as they are able to be assembled together to form a pod. The first panel may have the same, substantially the same, or a different shape and/or dimensions than the second panel. The first and second panels can be assembled in any suitable position relative to each other. For example, the first panel and the second panel are assembled such that the plane of the first panel and the plane of the second panel can intercept at any suitable angle, for example, at a 90-degree angle.

The first panel and the second panel can be interlocked via a simple locking mechanism involving a first slit on the first panel that slides into a second slit on the second panel. Generally, the slit on each panel may be straight or curved, at any location on the panel, and have any suitable length, as long as they can be slide into each other and lock the two panels to form the marine pod. Alternatively, one of the two panels may contain a slit, and the other panel contains a portion that is configured to fit in the slit and lock the two panels. The locking of the first panel and the second panel is reversible. For example, a user can dismount the assembled marine pot by applying a force to separate the first panel from the second panel.

Typically, each of the first panel and second panel has a shape such that it contains at least two shoulders and at least two feet. For example, the marine pod assembled from the two panels may contain at least four shoulders, such as four shoulders, six shoulders, eight shoulders, ten shoulders, etc., and at least four feet, such as four feet, six feet, eight feet, ten feet, etc.

Each of the two or more shoulders on each of the two panels allows for the attachment of one or more substrates, such as one or more marine tiles or plugs, on top and/or on one side or both sides of the shoulder at any suitable angle relative to the shoulder. Each of the one or more substrates can be attached at the same, substantially the same, or different angles to the shoulder. The substrate may be attached via screws, clips, or plugs. The feet allow for placement of the pod at a desired location, such as on a sand or rocky bottom of the seashore line, slits at the bottom of estuary or stream, rocks, coral gravel, sea floor, floor of a river/stream, or bottom of a tank. In some embodiments, each of the feet may be adjustable, such as shortened or extended, to allow placement on an uneven floor. In some embodiments, the marine pods can be attached to each other to stabilize each other on the ocean floor and to provide an anchor for fixing the marine tiles to the bottom floor of a body of water such that the tiles can remain stationary in moving water.

For example, each of the first panel and the second panel is a unitary piece containing a first shoulder and a second shoulder, and a first foot and a second foot. The first shoulder and the second shoulder forms an angle α. The angle α may be any suitable angle that allows the attachment of one or more substrates on each of the two shoulders. The first foot extends from the first shoulder via a first extending portion and the second foot extends from the second shoulder via a second extending portion. The first foot is connected to the second foot via a curved connecting portion. The first foot and the second foot may be in the same plane or in different planes that form a suitable angle. The first foot and the second foot may have any suitable relative positions, such as parallel to each other, pointing outwards from each other, or pointing to each other. The assembly of such a first panel and second panel provides a marine pod similar to a Quattro pod with a four-foot stand.

FIG. 8 shows an exemplary marine pod 200. Marine pod 200 includes a first panel 210 and a second panel 220. First panel 210 is a unitary piece containing a first shoulder 212 and a second shoulder 216. First shoulder 212 and second shoulder 216 forms an angle α that is suitable for attachment of substrates on both shoulders. One or more substrates can be attached on the top side of the shoulder, on the left/right side of the shoulder, on both left and right sides of the shoulder, on the top side and the left/right side of the shoulder, or on the top and both left and right sides of the shoulder. Cutouts 201 and 203, one on each shoulder of the first panel, are for attaching the substrates and/or attaching the marine pod at a desired location. A first foot 214 extends from the first shoulder 212 downwards via a first extending portion 213. A second foot 218 extends from the second shoulder 216 downwards via a second extending portion 217. The first foot 214 and second foot 218 are connected via a curved connecting portion 215. The first foot 214 and second foot 218 are in the same plane and are in parallel to each other. A first slit 219 is located in the center of the curved connecting portion 215, and connects the curved outer border 211 of the curved connecting portion 215. First slit 219 is perpendicular or substantially perpendicular to the horizontal plane. Second panel 220 is also a unitary piece. The reference numbers and corresponding descriptions with respect to the first panel 210 generally apply to the second panel 220. However, the proportions and angles can be different and a second slit 219′ is at a different location. Second slit 219′ on the second panel 220 is a cut from the contacting point 221 of the two shoulders and pointing perpendicular downwards. The first slit 219 can slide into the second slit 219′ and lock the first panel 210 and the second panel 220 such that the plane of the first panel and the plane of the second panel intercept at a 90-degree angle. The marine pod 200 after assembly is similar to a Quattro pod with a four-foot stand.

ii. Marine Pods with Marine Tiles

As described above, each of the two or more shoulders of each panel allows for the attachment of one or more substrates, such as one or more marine tiles or plugs, on top and/or on one side or both sides of the shoulder at any suitable angle relative to the shoulder. Each of the one or more substrates can be attached at the same, substantially the same, or different angles to the shoulder. For example, each of the one or more substrates can be attached at the top side of a shoulder, where the substrate aligns along the top side of the shoulder. The substrate may be attached via screws, clips, or plugs. Each shoulder may include one or more attachment sites, such as in the form of cutouts, to facilitate attachment of the substrates on the shoulder.

Any marine titles described above can be attached to the shoulder of the marine pod, such as marine titles without 3D structures, tiles with 3D structures, tiles with the marine organisms, and tiles with a 3D structure and marine organisms. For example, a tile without 3D structures and without marine organisms (blank tiles) can be attached on the top side of each shoulder of a marine pod, where the tile aligns along the top side of the shoulder (see, e.g., FIG. 9A). Alternatively, a tile with coral can be attached on the top side of each shoulder of a marine pod, where the tile aligns along the top side of the shoulder, and where each tile can contain a coral that is the same, substantially the same, or different in type, size, shape, and/or color from the other tiles attached on the same marine pod (see, e.g., FIG. 9B).

Further, holders with two or more tiles or organisms may be attached to the shoulders and/or side of the marine pod to increase the carrying capacity of the pods.

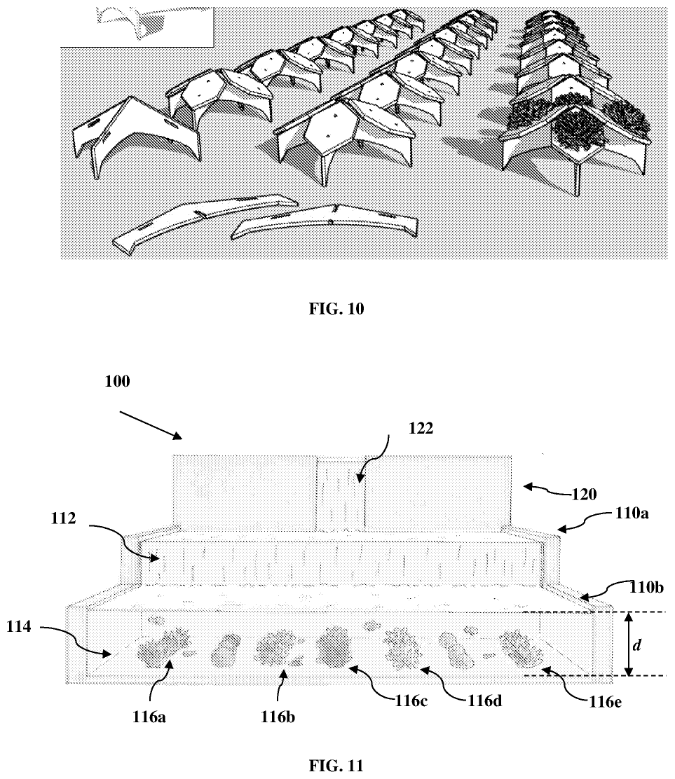

In some embodiments, two or more marine pods, where each of the two or more marine pods have one or more marine tiles attached to the top side of one or more shoulders of the marine pod, may be arranged to form a desired pattern (see, e.g., FIG. 10).

C. Marine Tanks

Terraced or individual marine tanks to display, raise, and nurture benthic marine organisms (e.g., corals, clams, etc.) are provided. The marine tanks are intended as to serve as landscaping and architectural feature to achieve environmental, educational, and aesthetic outcomes which separates these tanks from conventional tanks.

The marine tank typically contains one or more coral reef organisms. The coral reef organisms can serve as a beautification feature and/or support the growth and health of other organisms, such as clams, sponges, algae, fishes, or a combination thereof. Typically, the one or more coral reef organisms are placed at a depth of at least 10 cm from the water level. The coral reef organisms can be placed on a substrate such as the marine tiles disclosed herein.

Generally, the marine tank includes a terraced or individual seawater tank and optionally a vertical wall. The seawater tank may have any suitable shapes, such as regular shapes (e.g., rectangular, square, circular, etc) and irregular shape (e.g., curved or sloped). The vertical wall is connected to the horizontal surface of the terraced or individual seawater tank. The vertical wall may contain a hollow reservoir for holding seawater. The terraced or individual seawater tank may be made by any suitable solid materials, such as concrete or glass (e.g., fiberglass, acrylic glass, laminated glass, etc.). Optionally, the seawater tank is open at the top to allow natural light conditions, which may be altered via shading. The marine tank may contain lighting features inside the seawater tank and/or at any locations outside the seawater tank, such as on the vertical wall or fixed above the seawater tank, when natural light is insufficient. The marine tank may also contain artificial illumination features at any locations inside and/or outside the seawater tank to showcase fluorescence of marine organisms and to create nocturnal landscapes features.

In some embodiments, the seawater tank is a terraced tank. The terraced tank may contain two or more levels, such as two levels, three levels, four levels, etc. The one or more coral reef organisms are typically displayed in the bottom level. Typically, the bottom level of the terraced tank contains transparent windows at the front side, i.e., vertical to the horizontal layer forming the bottom of the tank, on the left and right sides, and/or at the back side for displaying the one or more coral reef organisms and optionally one or more additional marine organisms such as clams, sponges, algae, fishes, or a combination thereof. Alternatively, the entire bottom level is made of a transparent solid material, such as fiberglass, acrylic glass, or laminated glass. Each level of the terraced tank may have the same, substantially the same, or different shapes and dimensions. For example, the terraced tank contains two or more levels, where one of the two or more levels has a first shape, such as a circular shape, and one or more of the levels have a second shape that is different from the first shape, such as a rectangular shape. Each level may have a width between 50 cm and 200 cm and a length between 150 cm and 1000 cm.

Referring to FIG. 13, for example, a terraced tank 300 in one embodiment, contains three levels, where the first terrace level 310 and second terrace level 320 have a half-circular shape and the third terrace level 330 has a rectangular shape. With respect to the relative size, the third terrace level 330 is larger than the second terrace level 320 and the second terrace level is larger than the first terrace level 310 (see, e.g., FIG. 13). The one or more coral reef organisms are displayed in the third terrace level 330 (i.e., the bottom level).

For example, the terraced tank contains two levels, where the first terrace level is connected to the vertical wall and the second terrace level (i.e., bottom level) contains coral reef organisms and optionally additional marine organisms (e.g., clams, sponges, algae, fishes, etc.).

The first terrace level may be a water reservoir or a solid surface onto which seawater can cascade down to the second terrace level. The first terrace level may have any suitable shape and dimensions. For example, the first terrace level is rectangular in shape and has a width and length described above. The height of the first terrace level is typically between about 1 and 20 cm, between 1 and 15 cm, between 1 cm and 10 cm, between 1 cm and 8 cm, between 1 cm and 6 cm, between 1 cm and 5 cm, between 1 cm and 4 cm, between 1 cm and 2 cm, such as 2 cm, 4 cm, 5 cm, 6 cm, 8 cm, or 10 cm.

The second terrace level (i.e., bottom level) can contain one or more coral reef organisms and one or more additional marine organisms described above to form a coral garden. Optionally, the second terrace level may only contain one or more coral reef organisms to serve as an ex-situ nursery for coral reef organisms. In some embodiments, the marine tank contains more than one coral reef organism, where the coral reef organisms can have different shapes, sizes, and colors. The one or more coral reef organisms and optionally additional marine organisms may have any suitable arrangements, such as on the bottom and/or on the wall of the second terrace level to form any desirable patterns. Typically, the one or more coral reef organisms are located at a depth of at least 10 cm from the water level of the second terrace level.

The second terrace level may have a regular shape (e.g., rectangular, square, circular, etc) or an irregular shape (e.g., curved or sloped). For example, the second terrace level has an irregular shape with a sloped bottom such that it has different depths at different locations from the water level. Typically, the second terrace level has a minimum depth (d) of 10 cm. Seawater flows through the marine tank constantly. The second terrace level may contain pipes connected to a pump to allow inflow of fresh seawater to keep temperatures in the seawater tank consistent (i.e., less than 32° C.) by distributing fresh seawater to create a high flow environment. The seawater can flow out of the tank through an outlet located at the bottom or on the side of the tank. The inflow and outflow of seawater allows imitation of a river stream inside the tank. The second terrace level may also contain one or more areas for collecting debris/dust that can be siphoned out periodically from one or more outlets, such as at least every 1 day, every 2 days, every 3 days, every 5 days, every week, every two weeks, or every month. The outlets for collecting debris/dust may be the same or different from the seawater outflow outlet. Optionally, the second terrace level contains one or more support surface, such as a table, placed at various depths to hide pipes and/or pump for seawater inflow and to provide support to nurture the coral reef organisms.

Optionally, the seawater tank is an individual tank. The individual tank can have any configurations described above for the bottom terrace level and optionally is connected to the vertical wall.

Marine organisms may be equally spaced and distributed in the tanks using stands/holders to allow automatic assessments of growth and other parameters using camera and sensor systems either located stationary in the tanks or on robotic systems that may move through the system. The stands may hold and position one or more tiles, coral fragments or other marine organisms. Phototropic organisms shall be directed towards the surface or light source either in a horizontal angle or any other angle depending on the organisms growth form.

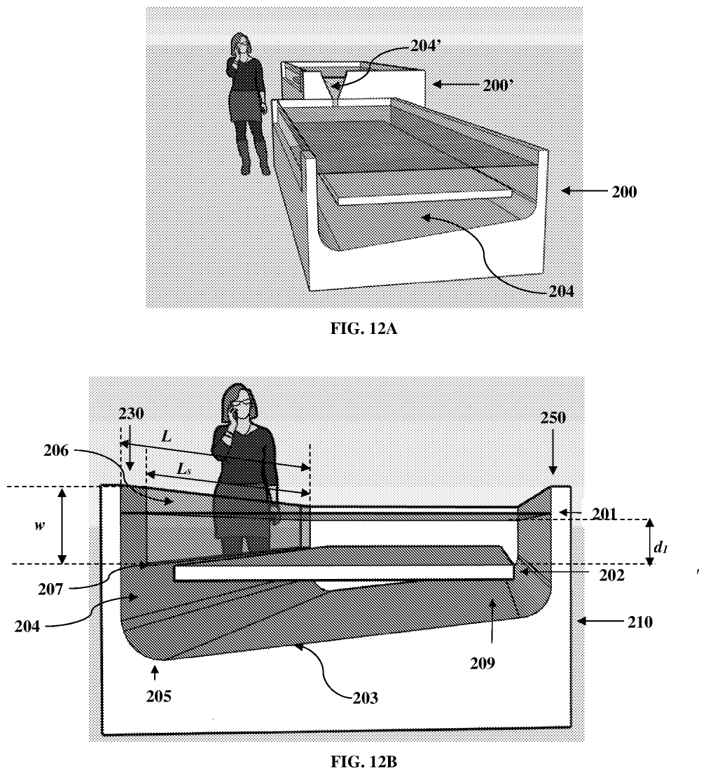

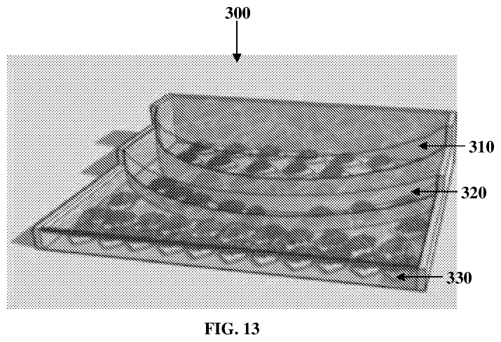

FIGS. 11 and 12A-12B depict exemplary marine tank 100 and exemplary bottom terrace level/individual seawater tank 200 and 200′. As shown in FIG. 11, marine tank 100 includes a terraced levels 110a and 110b and a vertical wall 120. The terraced tank contains two levels, first terrace level 112 and second terrace level 114. The vertical wall 120 is connected to the horizontal surface of the first terraced level 112 of the seawater tank 110. The vertical wall 120 contains a hollow reservoir 122 for holding seawater. The first terrace level 112 may be a water reservoir or a solid surface onto which seawater can cascade down to the second terrace level 114. The second terrace level 114 (i.e., bottom level) contains coral reef organisms (see, e.g., 116a-116e) patterned at the bottom of the second terrace level 114. The depth (d) of the second terrace level 114 is at least 10 cm. The coral reef organisms (see, e.g., 116a-116e) can have different shapes, sizes, and/or colors. The second terrace level 114 is open to the top to allow natural light conditions.

As shown in FIG. 12A and FIG. 12B, tank 200 is a bottom terrace level of a terraced seawater tank or an individual seawater tank. Tank 200 contains a sloped bottom 203 to create different depths in the tank from water level 201. The tank 200 contains one or more pipes and/or pump located in an area 209 inside the tank to allow inflow of fresh seawater, which distributes the fresh seawater to create a high flow environment. The seawater can flow out of the tank 200 through an outlet located at the bottom or on the side of the tank. The inflow and outflow of seawater allows imitation of a river stream inside the tank. The tank 200 contains an area 205 at the deep side of the tank to collect debris/dust. The debris/dust can be siphoned out periodically through the seawater outflow outlet or a different outlet located at/near the bottom of the deep side of the tank. The tank 200 also contains a table 202 placed at a depth (di) from the water level 201 that is above the one or more pipes and/or the pump to hide the one or more pipes and/or the pump, and to provide support to nurture the coral reef organisms. Current/wave pumps that may be located underneath the table may be positioned to generate water flows circulating the table. The table may be adjustable to generate different depth (di). The tank 200 contains a transparent window 204 on one side 210 of the tank and a transparent window 206 at the front of the tank to display the marine organisms natured on the table. Window 204 has a size and irregular shape that covers the area formed by the side 210, the front side 230, and the back side 250 of the tank. Window 206 is rectangular in shape and has a width (w) such that the bottom 207 of the window 206 is at the same or substantially the same level as the surface of the table 202. In one embodiment, the table 202, is stationary, i.e., it is not a rotating table. Window 206 has a length (La) that can be the same, substantially the same or shorter than the length (L) of the tank 200.

Tank 200′ in FIG. 12A depicts a bottom terrace level of a terraced seawater tank or an individual seawater tank of similar configuration as tank 200, but having a side window 204′ of a different shape and size than the side window 204 of tank 200.

### II. Methods of Using the Compositions

The disclosed marine tiles and marine pods can be used in, for example, eco-tourism, harbor, underwater landscapes or other marine/aquatic construction projects that create artificial structures underwater and would like to beautify these as well as to use these to garden marine organisms.

A. Underwater Gardens

The marine tiles and/or marine pods can be used for constructing underwater garden inside or outside the ocean. The underwater gardens may be complemented by the use of the tiles or pods but could also be designed without these components. In this embodiment, a botanical garden is transferred underwater and used to display species assemblies to visitors for entertainment and educational purposes.

For example, the marine tiles and/or marine pods containing different benthic marine organisms on the tiles can be arranged and placed at a predetermined depth and locations in the ocean along an itinerary designed for visitors to be educated and informed about marine life while enjoying the aesthetics of the garden. The use of marine tiles and/or marine pods in an artificial garden in the ocean transfers the idea of a terrestrial botanical garden to the marine environment, where species are curated and strategically placed in a biological, scientific or educational matter to display and maintain aquatic diversity in the garden with itineraries designed for visitors.

Most typically an aquatic zoo-botanical garden, can be created as, for example, a tourist attraction and to increase guest experiences in tourist projects. The concept caters toward the eco-tourism and dive-tourism industry.

In some embodiments, the artificially created underwater gardens using marine tiles and marine pods target to entertain and educate visitors snorkeling, on SCUBA or using other diving techniques and may extend across various habitats/depths. FIG. 11 illustrates certain non-limiting aspects of embodiments of an exemplary garden in the ocean constructed using the disclosed marine tiles and marine pods.

The gardens can contain a visual and/or audio information system embedded in or affixed on the marine tiles and/or marine pods to guide visitors through the living exhibition in flexible itineraries. Instead of simply creating an artificial habitat for aquatic species, the aqua zoo-botanical garden aims at showcasing different species/species assemblies in an educative and/or scientific matter in the marine environment, similar to the concept of a terrestrial botanical garden.

The gardens may attract visitors away from vulnerable natural habitats to reduce (e.g., diving) pressure on these systems, to make these communities available to visitors that cannot access them in the wild, and to educate visitors about aquatic organisms by exhibiting species diversity accompanied by explanatory materials. Hereby, organism may be grown on tiles, pods or other artificial or natural substrate imitating natural reef assemblies for display purposes.

Alternatively, the marine tiles and/or marine pods may be used for the beautification of marine tanks in landscaping, both indoor and outdoor. For example, the marine tiles and/or marine pods containing different benthic marine organisms on the tiles can be arranged and placed at the bottom of a marine tank to form any desirable patterns or as components of a mosaic. FIG. 12 illustrates certain non-limiting aspects of embodiments of an exemplary garden in a marine tank constructed using the disclosed marine tiles and marine pods. The marine tiles and/or marine pods may include lighting features and/or artificial illumination features to showcase fluorescence of marine organisms and/or to create nocturnal landscapes.

B. Aquatic Living Genebanks

The marine tiles and/or marine pods can also be used for constructing Aquatic Living Genebanks (ALG) in artificial facilities or submerged in the marine environment. An ALG is an artificial underwater culture/farm of benthic marine organisms (e.g., corals, clams) grown to create a living catalog of genotypes representative of a species in order to conserve/preserve the regional genotypic diversity.

Each of the disclosed marine tiles and/or marine pods can include unique marks/labels or tracking devices as described above, such that individual organism contained in each of the marine titles and/or marine pods in the ALG can be, for example, labeled, cataloged, subsampled (tissue preserved for future genetic analysis), or a combination thereof. Their final location in the ALG can also be precisely mapped/recorded for future reference.

### III. Methods of Using the Marine Tanks

The marine tanks disclosed herein can restore, educate, and enhance coral reef gardening. They may be used in, for example, ecotourism projects, hotels, golf courses, or other construction projects that need to beautify their landscape/architecture with marine organisms. The tanks can be integrated into the landscape as well as part of architectural features of hotels, restaurants, golf courses, hotel lobbies, bathrooms, etc.

For example, the disclosed marine tanks can serve as a beautification feature that compliments or replaces conventional flower beds or other vegetation in landscape architecture. For example, the coral reef organisms displayed in the marine tanks can be used as mosaics in landscape (indoor and outdoor) elements to produce a diversity of patterns, which can be combined with the technology to support the growth and health of the organisms other than coral reef organisms, such as clamps.

The disclosed marine tank is preferably a flow through system. The flow of seawater through the marine tanks imitates a river stream, such that the marine tank can be placed at a marine organism developmental site or along a harbor walkway, inside or outside. Seawater is cascading from one tank segment to another or flow indirectly into the next segment, whereby each tank segment has an individual seawater inflow supplying it with fresh seawater to maintain good water qualities. The water moves through gravitational forces from one level to the other. Current conditions in each tank are adjusted via pumps to the individual needs of the kept organisms.

Typically, a method of using the disclosed marine tanks includes (i) pumping seawater through the marine tank. The seawater can be a natural seawater or an artificial seawater. The seawater can be pumped from the sea directly to and through the marine tank. Alternatively, the seawater can be pumped from the sea to a holding tank or a Life Support System (LSS), then from the holding tank or LSS through the marine tank. Optionally, the method includes a step of treating the seawater (e.g., cooling, heating, filtering, etc.) prior to flowing through the marine tank.

In embodiments where the marine tank contains a terraced seawater tank, the seawater typically drips from the upper terrace level, cascading downwards by gravity onto the subsequent level/levels, and flows with controls (e.g., flow rate) to maintain temperature within the range tolerated by the marine organisms included in the design. Alternatively or additionally, each level of the terraced tank contains one or more pipes for an inflow of fresh seawater to produce a high flow environment, such that a consistent temperature that is less than about 32° C. is kept inside each level or the bottom level of the terraced seawater tank.

Alternatively, the marine tank contains an individual seawater tank. The seawater can drip or cascade downwards by gravity from a reservoir on a vertical wall connected to the individual seawater tank. Alternatively or additionally, the individual seawater tank can contain one or more pipes for an inflow of fresh seawater to produce a high flow environment, such that a consistent temperature that is less than about 32° C. is kept inside the individual seawater tank.

In some embodiments, the disclosed marine tanks can serve as an ex-situ nursery for coral reef organisms, seeded by selected coral fragments relocated and retrieved from nature, supplying, followed by 1 to 2 years of growth in the coral gardens, underwater reefs, including those in need of restoration, expansion or for the creation of artificial habitat.

1. A marine tile comprising a first face and second face,
wherein the first face comprises a combination of projections and spaces that together form a 3D pattern.

2. The marine tile of claim 1 further comprising one or more attachment sites for attaching to an artificial supporting substrate.

3. The marine tile of claim 1 further comprising a mark, a label, or a miniature electronic transmitter tracking device.

4. A marine tile comprising
a first face;
a second face; and
one or more sites for supporting one or more marine organisms,
wherein the one or more sites are located on the first face.

5. The marine tile of claim 4 further comprising one or more attachment sites for attaching to an artificial supporting substrate.

6. The marine tile of claim 4, wherein the first face comprises a combination of projections and spaces that together form a 3D pattern.

7. The marine tile of claim 4, wherein the one or more marine organisms comprises coral and/or each of the one or more marine organisms is glued, cemented, clipped, or plugged to one of the one or more sites, optionally, further comprising a mark, a label, or a miniature electronic transmitter tracking device.

8. (canceled)

9. (canceled)

10. An artificial structure comprising
an artificial supporting substrate, and
a plurality of the marine tiles of claim 1,
wherein the marine tiles are positioned individually or clustered together.

11. The artificial structure of claim 10, wherein: (a) the artificial supporting substrate is a bridge pile, an overwater villa pile, or a jetty pile; (b) the plurality of marine tiles are positioned to form a mosaic pattern; and/or (c) the marine tiles are attached to the artificial supporting substrate via screws, clips, glue, or nails.

12. (canceled)

13. (canceled)

14. A marine pod comprising
a first panel, wherein the first panel comprises a first slit;
a second panel, wherein the second panel comprises a second slit,
wherein the first panel and the second panel are interlocked via sliding the first slit into the second slit.

15. The marine pod of claim 14, wherein the first panel and the second panel intersect at a 90-degree angle and optionally, further comprising one or more marine tiles comprising a first face and second face,
wherein the first face comprises a combination of projections and spaces that together form a 3D pattern.

16. (canceled)

17. A method for constructing an underwater garden comprising positioning a plurality of the marine tiles of claim 1 at a predetermined depth in the ocean; or
positioning a plurality of the marine tiles and/or the plurality of the marine pods at the bottom of a marine tank.

18. (canceled)

19. (canceled)

20. (canceled)

21. A marine tank comprising a seawater tank and one or more coral reef organisms selected from the group consisting of clams, sponges, algae, and fish.

22. (canceled)

23. The marine tank of claim 21 further comprising a vertical wall connected to the horizontal surface of the seawater tank.

24. The marine tank of claim 21, wherein the seawater tank comprises: (a) one or more levels; (b) one or more pipes connected to a pump, and
wherein the pump is located inside or outside the seawater tank; (c) one or more transparent windows for displaying the one or more coral reef organisms; (d) an opening at the top, and wherein the opening allows the passage of natural or artificial light.

25. (canceled)

26. The marine tank of claim 21, wherein: (a) the seawater tank comprises more than one level, and wherein the one or more coral reef organisms are placed in the bottom level of the seawater tank; (b) the one or more coral reef organisms are placed at a depth of at least 10 cm from the water level.

27. (canceled)

28. (canceled)

29. (canceled)

30. The marine tank of claim 21 further comprising one or more lighting features and/or artificial illumination features located inside and/or outside the seawater tank.

31. (canceled)

32. The method of claim 3130, wherein the seawater is directly pumped from the sea through the marine tank, or
wherein the seawater is pumped from the sea to a holding tank or a Life Support System (LSS), then from the holding tank or LSS through the marine tank.

33. The method of claim 30 further comprising a step of cooling, heating, or filtering the seawater prior to flowing through the marine tank.

34. The method of claim 32, wherein (a) the seawater tank comprises more than one level, and wherein the seawater flows from an upper level and cascades downwards to a lower level/levels; (b) the flow of the seawater is controlled such that a consistent temperature is maintained in the marine tank, and wherein the temperature is less than 32° C.

35. (canceled)
